(19) United States
(12) Patent Application Publication
(10) Pub. No.: US 2004/0184392 A1
(43) Pub. Date: Sep. 23, 2004

(54) Copy-protected optical recording medium and a method for manufacturing thereof

(76) Inventor: Heung-Chan Seung, Seoul (KR)

Correspondence Address: STAAS & HALSEY LLP, SUITE 700, 1201 NEW YORK AVENUE, N.W., WASHINGTON, DC, 20005, US

(21) Appl. No.: 10/477,581

(22) PCT Filed: Mar. 26, 2002
(86) PCT No.: PCT/KR02/00517

(51) Int. Cl. G11B 7/24

(52) U.S. Cl. 369/275.3

(57) ABSTRACT

A copy-protected optical recording medium and a method for manufacturing thereof is provided, wherein the recording medium includes a main content session and an auxiliary session on which digital version of content information stored on the main content session.

### TECHNICAL FILED

The present invention relates to a copy-protected optical recording medium on/from which digital contents such as audio contents recorded/reproduced and a method for manufacturing thereof, and more particularly to an optical recording medium prevented from being copied by manipulating control information in a lead-in area and a method for manufacturing thereof.

The present invention relates to an optical recording medium, which is or will be in existence, such as an audio compact disc, a combination of compact discs, a compact disc including other optical recording medium and a compact disc included in other optical recording medium.

### BACKGROUND ART

As known so far, the optical recording medium recording information on one side or both sides of it has been used for various purposes, especially in music, game, video and computer industries. Digital information is recorded in a form of pits with a predetermined size and interval along the tracks formed on one side or two sides of the disc.

According to “copy managing system of an optical disc”(Korean Patent Application Publication No. 1999-23961), one of the methods already known, manufacturing an optical recording medium as mentioned above, a glass master first is formed by exposing a photoresist spread over a glass substrate using a laser or light. The exposed pattern corresponds to the pattern of the digital information recorded in the disc last.

Then an indentation, which is called a pit, is formed in the single spiral of the glass master by removing the exposed area through etching or developing process. The pattern and length of the indentation along the tracks represent the recorded information digitally. And a nickel master, which is a tool for molding duplicates in the following forming process, is then formed by applying the galvanized nickel to the glass master in the electroforming process.

The patterns of the nickel master, generally called a pit and a land (or mirror area) respectively, are formed by transcribing on a polycarbonate or PMMA substrate. The stamped duplicate is coated with a reflection layer and added a protection layer for preventing the reflection layer from oxidizing.

In order to read the optical recording medium manufactured in the manner above, the surface of the disc is irradiated to laser beams, which are oscillated with the predetermined frequency and power. There is a difference of the intensity of the reflected laser beams between in case the beams are applied to the mirror area and in case to the pit, and a reproducing apparatus (which is capable of only reproducing the optical recording medium) including a reading part, called the optical pick-up, recognizes the difference of the intensity of the reflected beams as digital information of 0 or 1 so that the digital information recorded on the optical recording medium can be reproduced.

The optical recording medium has developed from the compact disc (audio CD), which is mainly for reproducing the audio contents, and currently the compact disc is used for recording the data of a computer in a form of the read-only memory (CD-ROM) or reproducing the audio contents in a computer equipped with an audio CD driver by adding computer-readable information to the audio CD.

However, as the information recorded on the optical recording medium can be read by a reproducing apparatus, for example, a CD-ROM driver with which an general personal computer is equipped, the contents on the recording medium are not only reproduced, but also illegal copying of the contents prevails. Therefore, a serious problem how to protect the copyright of the contents on the recording medium rises.

Generally, when the audio CD or the CD-ROM is copied, the information on the lead-in area, namely TOC (Table Of Contents), such as the information recorded in the recording medium and the predetermined control information, should be read, so there has been a try to solve the problem above. That is, according to “CD reproducing control method without TOC” (Korean Patent No. 200879), in order to prevent the illegal copying of the information on the recording medium by removing the TOC of the CD-ROM or the audio CD and reproduce both the recording medium prevented from being copied illegally and a general recording medium, it is disclosed that a reproducing control method of a CD without a TOC for preventing the illegal copying, includes the steps of:

(1)verifying whether the TOC is read,

(2)going to a predetermined track and reading information from the track, if the TOC is not read in the step (1),

(3)verifying whether the information, which is read in the step (2), is read from the recording medium without the TOC and

(4)reading in accordance with a new format if the recording medium does not have the TOC, or reading in accordance with a general format if the information is from the lead-in area in the step (3).

According to the method above, However, there is a problem that it is impossible to reproduce the contents recorded on a copy-protected recording medium only with a general reproducing apparatus, because the TOC of the recording medium should be removed artificially, and the reproducing apparatus should be specially programmed and carried out in accordance with the steps above. That brings users a problem that they have to buy an appropriate reproducing apparatus anew besides the recording medium.

### DISCLOSURE OF INVENTION

Therefore, it is an object of the present invention to, provide a copy-protected optical recording medium capable of being reproduced by a general reproducing apparatus and a method for manufacturing thereof, which is capable of overcoming the above drawbacks accompanying the conventional art. The above and other objects can be achieved by combinations described in the independent claims. The dependent claims define further advantageous and exemplary combinations of the present invention.

According to the first aspect of the present invention, an optical recording medium protected from being copied by a general reproducing apparatus, comprising a main content session on which content information to be reproduced by the reproducing apparatus is recorded, the main content session comprising information indicating that the content information is a data content capable of being reproduced in support of a predetermined application program and an auxiliary content session on which auxiliary content information is recorded according to a method for protecting the data content from being copied, the auxiliary content information is formed by converting the content information.

The main content session may further comprise a lead-in area with a TOC, at least one track on which the content information is recorded and a lead-out area. The information indicating the content information is a data content capable of being reproduced in support of a predetermined application program may be recorded on the TOC. The content information may be audio information.

The application program may be provided by a computer system in which the reproducing apparatus is installed. The application program may be recorded on a predetermined area of the optical recording medium. The auxiliary content session may further comprise at least one OHD area provided in areas of the auxiliary contents.

The auxiliary content session may be further comprise at least one overlapping zone whose address values allocated to the auxiliary content overlap with address values of another area in the recording medium and driving information for controlling the reproducing apparatus to read information on the overlapping zone. The optical recording medium may further comprise at least two or more of the main content session.

According to the second aspect of the present invention, a method for manufacturing an optical recording medium protected from being copied by a general reproducing apparatus, comprising the steps of (a)forming a main content session on which content information to be reproduced by the reproducing apparatus is recorded and (b)forming an auxiliary content session on which auxiliary content information is recorded, the auxiliary content information is formed by converting the content information, wherein information indicating the content information is a data content capable of being reproduced in support of a predetermined application program is recorded on a predetermined area of the main content session in the step (a), and the auxiliary content information is recorded according to a method for protecting the data content from being copied in the step (b),

The main content session may further comprise a lead-in area with a TOC, at least one track on which the content information is recorded and a lead-out area. The information indicating that the content information is a data content capable of being reproduced in support of a predetermined application program may be recorded on the TOC. The content information may be audio information. The method for manufacturing an optical recording medium may further comprise the step of recording the application program onto a predetermined area of the optical recording medium.

The auxiliary content session may further comprise at least one OHD area provided in areas of the auxiliary contents. The auxiliary content session may further comprise at least one overlapping zone whose address values allocated to the auxiliary content overlap with address values of another area in the recording medium and driving information for controlling the reproducing apparatus to read information in the overlapping zone. The method for manufacturing an optical recording medium may further comprise the step of forming at least two or more of the main content session.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### DESCRIPTION OF DRAWINGS

FIG. 1 shows the information, of which a session consists, imaginarily placed in a row, and recorded on the audio CD in accordance with the Red Book Standard.

FIG. 2 shows the structure of one of frames of which the information block recorded on the lead-in area of the information shown in FIG. 1 consists.

FIG. 3 shows the structure of the Q sub channel of the 8 sub channels consisting of the control information of the frames shown in FIG. 2.

FIG. 4 shows the information, which is imaginarily placed in a row, recorded on the copy-protected optical recording medium according to an exemplary embodiment of the present invention.

FIG. 5 shows a series of pieces of the information, imaginarily placed in a row, recorded on from the innermost track to the outermost track of the auxiliary content session of the copy-protected optical recording medium according to the present invention, and the addresses allocated to the series of pieces of the information.

FIG. 6a shows the method for driving the copy-protected optical recording medium according to the present invention.

FIG. 6b shows a series of pieces of the information extracted from the auxiliary content session of the recording medium according to the progress shown in FIG. 6a.

FIG. 6c shows the information on the duplicated medium, when the information is copied from the auxiliary content session of the recording medium according to the sequence shown in FIG. 6a.

FIG. 7 is a schematic flow chart showing an exemplary embodiment of the method for manufacturing the copy-protected optical recording medium according to the present invention.

FIG. 8 shows the information, which is imaginarily placed in a row, recorded on the copy-protected optical recording medium according to another exemplary embodiment of the present invention.

### BEST MODE FOR CARRYING OUT THE INVENTION

The invention will now be described based on the preferred embodiments, which do not intend to limit the scope of the present invention, but exemplify the invention. All of the features and the combinations thereof described in the embodiment are not necessarily essential to the invention.

Embodiments of the present invention will be described with the attached drawings by taking a compact disc, a kind of an optical recording medium, as an example.

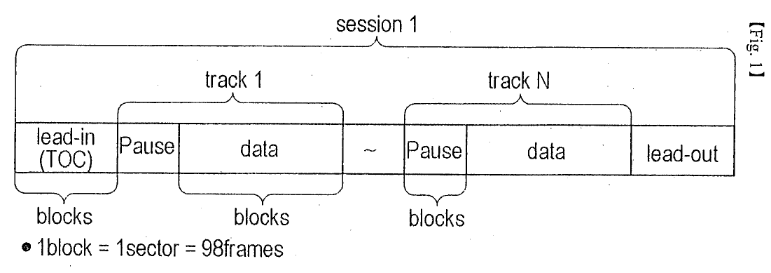

A standard, which is called “Red Book Standard”, has been presented in regard to a format for recording the audio contents, such as music, on the compact disc. According to the Red Book Standard, the audio CD has a number of tracks and the tracks are indexed and systematized. Referring to FIG. 1, FIG. 1 shows the information, of which a session consists, imaginarily placed in a row, and recorded on the audio CD in accordance with the Red Book Standard. As shown in FIG. 1, the audio information recorded on the audio CD includes a lead-in area, which is first accessed by a reproducing apparatus, a plurality of tracks(track 1 to track N), each of which includes both a pause area and a data area, and a lead-out area, which indicates the end of the session.

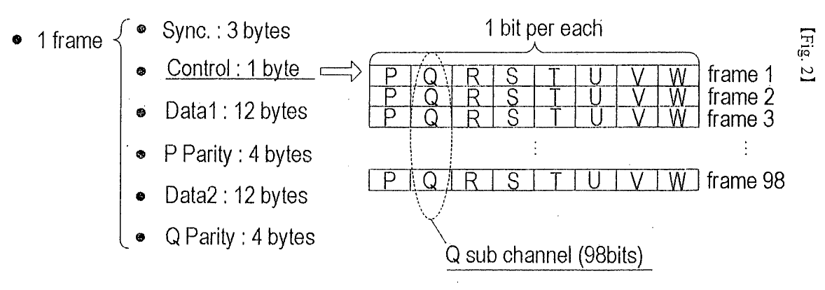

And also each of the area includes a plurality of information blocks (which are also called “sectors”), and a block includes 98 frames. Each of the frames, of which one of the information blocks recorded on the lead-in area consists, is composed as shown in FIG. 2. That is to say, a frame, which is recorded on the lead-in area, includes synchronization control information of 3 bytes (Sync), control information of 1 byte (Control), first content data information of 12 bytes (Data1), P parity information of 4 bytes (P Parity), second content data information of 12 bytes (Data2) and Q parity information of 4 bytes (Q Parity).

In other words, each of the 98 frames, of which one of the information blocks recorded on the lead-in area consists, includes the control information of 1 byte and the control information of 1 byte consists of 8 sub codes, each of which has information of 1 bit. Each of the 8 sub codes is called P, Q, R, S, T, U, V and W field respectively. The sub codes form 8 sub channels, each of which is called P, Q, R, S, T, U, V and W sub channel respectively, over the 98 frames included in one of the information blocks. Each of the sub channels consists of 98 bits altogether including 2 synchronization bits and 96 data bits.

FIG. 3 shows the structure of the Q sub channel of the 8 sub channels consisting of the control information above. Other sub channels (P, R, S, T, U, V and W sub channel) are similar to the Q sub channel but transfer different information. As shown in FIG. 3, the first 2 bits of the Q sub channel represent synchronization patterns S0 and S1. The synchronization patterns S0 and S1 are used for synchronizing the reproducing apparatus to rotate the recording medium with the constant leaner velocity.

Following the synchronization patterns S0 and S1, control (Cont) field of 4 bits is recorded, which indicates the number of audio channels of the contents recorded on the recording medium and the existence of emphasis, and especially may show whether the contents of the track are the audio contents or the data contents recording the computer readable information.

The next 4 bits are address (Adr) field and designate the mode for a format of the Q sub channel. Although mode 1, mode 2, mode 3 etc., for example, are known as the format of the Q sub channel, only the case that the address field value is “0001”, that is, the format mode is mode 1, will be described here as an example (if the Q sub channel has the format of mode 1, it has a structure like the format shown in FIG. 3).

Track number (TNO) field follows the address field. 8 bits included in the track number field has a value of 0 to 99 represented in Binary Coded Decimal (BCD) of the second order. Although the value generally indicates the number of the track, the track, where the track number field has a value of “00”, is the lead-in track, and the track, where the track number field has a value of “AA”, is the lead-out track.

Next, point (Point) field is generally used for indicating the contents by dividing in further detail, represented by the track number, and in this case 8 bits included in the point field has a value of 0 to 99 and indicates the index number in the track. Moreover, in this case three fields indicating an absolute time code of the fields of the Q sub channel shown in FIG. 3, namely, absolute minute (AMin), absolute second (ASec) and absolute frame (Afrm) field respectively have the absolute time values of the track. Here, the absolute time value means the time interval within which the content is reproduced from the first track to the track concerned during the reproduction of the overall recording medium, and the absolute time value is called “address” especially in case of the compact disc. It is because the absolute time value can be used as the information about what address in the recording medium certain information is recorded at.

The values of the Q sub channel and the absolute time code, however, may be used as a different meaning. That is, the value recorded on the absolute time code field (the absolute minute, the absolute second and the absolute frame field), indicates the number of the first track of the session, if the point field included in the Q sub channel of the lead-in area has a value of “A0”. Meanwhile, the value recorded on the absolute time code field indicates the number of the last track of the session, if the point field has a value of “A1”, and the value recorded on the absolute time code field indicates the address of lead-out area of the session, if the point field has a value of “A2”. Particularly, the value recorded on the absolute time code field indicates the address of the next session, if the point field has a value of “B0”, and the value recorded on the absolute time code field indicates the address of the first session of the recording medium, if the point field has a value of “C0”.

Following the point field, the three fields, minute (Min), second (Sec) and frame (Frm), having the information of 8 bits respectively are recorded as the relative time code fields of the track. The three fields indicate the relative time code of the track in the session.

Following the three fields, zero (Zero) field is included in front of the absolute time code fields. Finally, following the absolute time code fields, crc (CRC) field of 8 bits for error control is included.

Accordingly, by interpreting the information of the Q sub channel of the lead-in area, the reproducing apparatus for the optical recording medium is capable of judging which content is recorded, in which format, at which position on the recording medium and how much quantity of the content. That is, by the data on the control field, whether the content of certain track on the medium is the audio content or the information requiring the additional applications for the reproduction, namely, the data content.

According to the present invention, by manipulating the information on the control field and recording the content information doubly, when the recording medium is copied, the information required for duplicating the medium is not provided without influencing the normal reproducing operation of the reproducing apparatus so that the copy is protected.

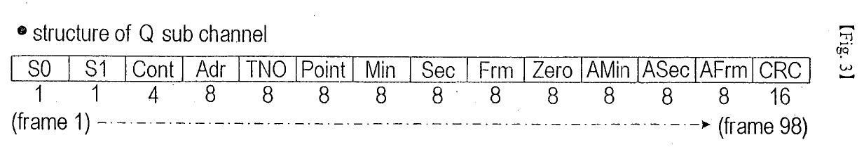

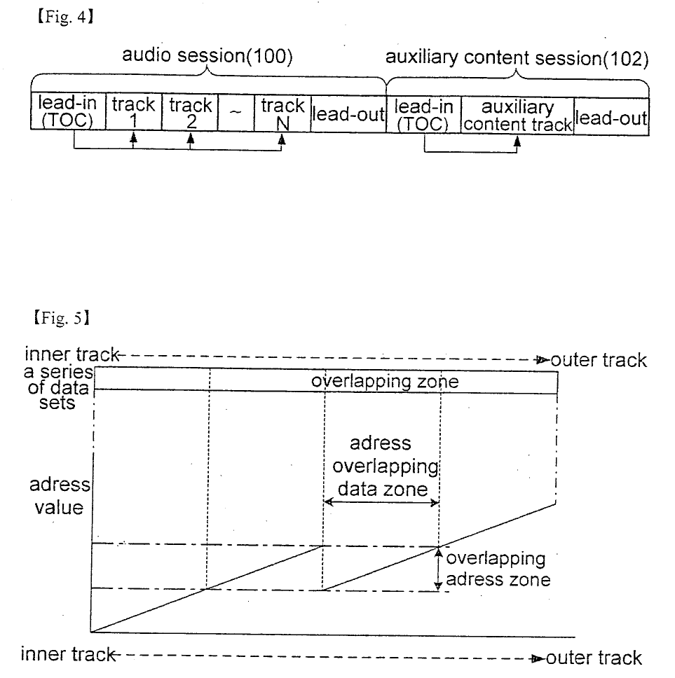

FIG. 4 shows the information, which is imaginarily placed in a row, recorded on the copy-protected optical recording medium according to an exemplary embodiment of the present invention. In the exemplary embodiment shown in FIG. 4, the present invention is applied to the audio CD. As shown in FIG. 4, the copy-protected audio CD according to the present invention includes a main content session 100 in which the audio contents are recorded, and a auxiliary content session 102 on which the information into which the audio contents on the main content session 100 are converted, which is added in order to protect the copy.

According to the embodiment, the main content session 100 includes a lead-in area with a TOC, at least one track(track 1 to track N) in which the main contents are recorded and a lead-out area. Particularly, the TOC of the main is content session 100 includes the information indicating the contents on the tracks are not the audio contents but the data contents.

The auxiliary content session 102 include a lead-in area with a TOC, an auxiliary content track in which the auxiliary contents are recorded and a lead-out area. For example, the auxiliary contents may be MP3 files into which the audio contents are converted in MP3 way. Certain application programs are necessary to reproduce the auxiliary contents, but these applications can be provided by the computer system with the reproducing apparatus. According to this embodiment, however, the applications can also be available by recording them onto the optical recording medium in accordance with the present invention.

Particularly, the auxiliary contents are recorded on the auxiliary content session 102 according to the present invention by the method presented by the application titled “method for manufacturing copy-protected optical disc and optical disc therefor”(Korean Patent Application No. 2001-200805). For example, the auxiliary content session 102 may includes at least one OHD area placed between the areas of the auxiliary contents.

Alternatively, the auxiliary content session 102 may includes at least one overlapping zone in which the address values allocated to the auxiliary contents overlap each other and the driving information for controlling the reproducing apparatus to read the information on the overlapping zone. This will be described later.

Furthermore, as a method for protecting the copying of the data contents in order to record the information on the auxiliary content session 102, it may not be publicized or developed until this application is filed. The method for protecting the copying of the data contents in order to record the information on the auxiliary content session 102 may be variously changed according to the formation of the embodiment of the present invention, and the choice of the methods is merely the optional matters in designing, so this will not be described further.

In this way, it is possible to reproduce the main contents on the main content session 100 either directly according to the kind of the reading apparatus(not shown in drawing) during the reproduction of the audio CD in accordance with the present invention, or by extracting the auxiliary contents on the auxiliary content session 102 and with the support of the corresponding applications.

If copying the audio CD according to the present invention, however, a recording apparatus(e.g., a CD-ROM driver; not shown in drawing) misreads that the information on the main content session is not the audio contents but the data contents by the control field of the TOC in the main content session 100, and thus can not copy the contents properly.

Moreover, because the auxiliary contents of the auxiliary content session 102 are recorded by the method for protecting the copying of the data contents described in regard to FIG. 1 to FIG. 3, the recording apparatus cannot copy the contents. Therefore, any part of the recording medium according to the present invention is not copied successfully.

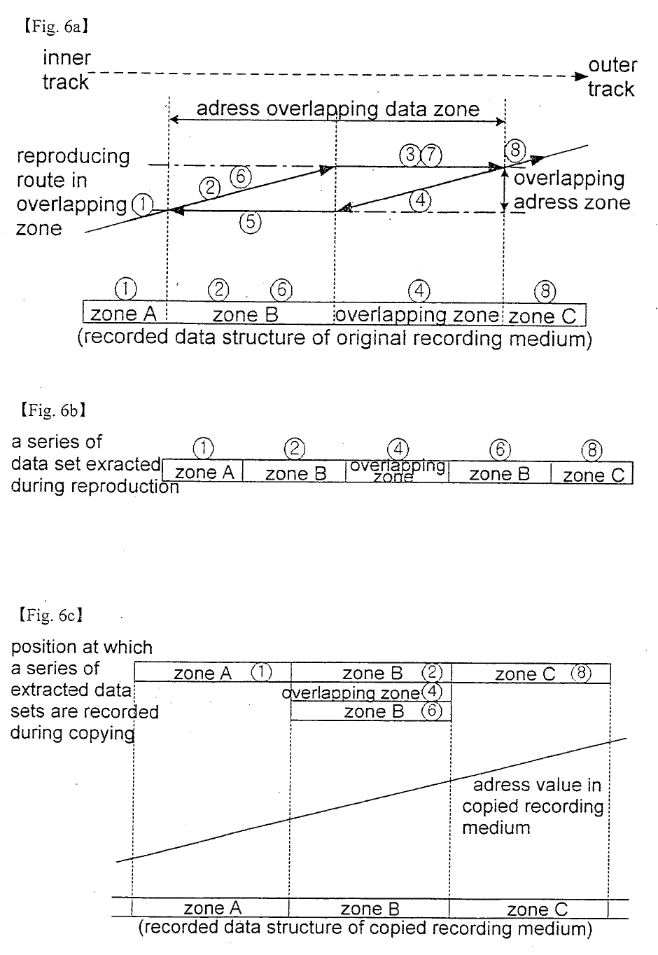

Here, the exemplary embodiment of the present invention, where the auxiliary content session 102 includes the overlapping zone whose address values overlap will now be described in detail with FIG. 5, FIG. 6a, FIG. 6b and FIG. 6c.

That is, as shown in FIG. 5, the auxiliary content session 102 includes at least one overlapping zone whose addresses allocated to the information on the medium overlap each other. The addresses may be either the physical addresses or the logical addresses. If the physical addresses overlap, the overlapping zone can be embodied by forming a zone whose addresses overlap at a predetermined position on the medium during manufacturing the medium. If logical addresses overlap, the overlapping zone can be embodied by recording the data different from others on an area, in which each of the physical addresses different from others is allocated, of the medium but allocating the logical addresses to overlap each other in a predetermined area. In FIG. 5, we see the addresses in the overlapping zone and the previous zone, namely the zone B overlap.

Moreover, the copy-protected optical recording medium according to the present invention further includes the driving information for controlling the reproducing apparatus for reading the information recorded on the overlapping zone. The data on the zone B has the same address value as that of the corresponding data on the overlapping zone, so the driving information is for driving the reproducing apparatus to access the addresses respectively.

That is, referring to FIG. 6a, FIG. 6a shows the method for driving the copy-protected optical recording medium according to the present invention. In order to reproduce the auxiliary content session 102 according to this embodiment, the already known reproducing apparatus(not shown) for the optical recording medium may be used. Here, we assume that the general reproducing apparatus reads the information from the least address value to the largest address value of the medium in increasing sequence.

According to the assumption above, the reproducing apparatus first reads the information on the zone A whose address values are relatively small(\mathring{1}), and goes on toward the zone B whose address values are larger than those of the zone A(\mathring{2}).

After finishing reading the information of the zone B, the reproducing apparatus progresses toward the front of the zone C whose address values are larger than those of the zone B in order to read the information of the zone C(\mathring{3}).

At this time, the driving information instructs the reproducing apparatus to perform the reading operation backwardly(‘reverse progress instruction’). Accordingly, the reproducing apparatus starts to read the information toward the area whose address value gets small, that is, from the back to the front of the overlapping zone(\mathring{4}).

Even after finishing reading in the overlapping zone, the reproducing apparatus keeps on progressing toward the area whose address value decreases. In other words, the reproducing apparatus progresses toward the back of the zone A(\mathring{5})

At this time, the driving information gives the reverse progress instruction to the reproducing apparatus to perform the reading operation backwardly again. Consequently, the reproducing apparatus reads the information on the zone B whose address value gets large again(\mathring{6})

As finishing reading in the zone B, the reproducing apparatus goes on toward the front of the zone C again(\mathring{7}), and then reads the information on the zone C(\mathring{8}).

Therefore, by recording the driving information for giving the reverse progress instruction mentioned above to the reproducing apparatus onto the recording medium, the information on the overlapping zone is read.

According to the embodiment above, the information on the area whose address value is the same as that of the overlapping zone, namely, on the zone B is extracted repeatedly in case either the reading position of the reproducing apparatus gets into the overlapping zone in the forward reading progress or the reading position of the reproducing apparatus gets out of the overlapping zone in the backward reading progress. A series of pieces of the information extracted from the auxiliary content session 102 of the copy-protected optical recording medium according to the present invention are shown in FIG. 3b, when the general reproducing apparatus reproduces the medium.

Meanwhile, according to another exemplary embodiment, in order to prevent the information on the zone B from being extracted repeatedly, when the reproducing apparatus attempts to read the information on the back of the zone A(i.e., after finishing the process \mathring{5}), jumping address instruction may be added to the reverse progress instruction, the jumping address instruction for instructing the reproducing apparatus to go straight to the front of the zone C. Alternatively, redundant information ignoring instruction may be added, which instructs the reproducing apparatus to ignore the information extracted repeatedly on the zone B.

The method for driving the reproducing apparatus before or after the overlapping zone is retrieved as mentioned above can be various besides the examples above.

In the meantime, the driving information is activated to be read by the reproducing apparatus and drive the reproducing apparatus. As the method for activating the reproducing apparatus, there can be various methods such that the driving information is read from the recording medium, then loaded into the memory of the reproducing apparatus and then makes the CPU control the operation of the reproducing apparatus.

Referring to FIG. 6b again, FIG. 6b shows a series of pieces of the information extracted from the auxiliary content session 102 of the copy-protected optical recording medium according to the present invention when reading it in the sequence shown in FIG. 6a. As shown in FIG. 6b, the information on the zone A is extracted, then the information on the zone B, then on the overlapping zone, then on the zone B once again and then on the zone C. Therefore, according to the present invention, even if using the general reproducing apparatus, it is possible to reproduce the whole information on the recording medium by the present invention normally.

When somebody, however, attempts to copy the information on the recording medium according to the present invention by a method already known or newly developed after this application, in order to record the information from the zone B to the overlapping zone onto the duplicated medium he or she should use the address data the same as that allocated to the areas. Consequently, only one of the pieces of the information from the zone B to the overlapping zone is recorded on the zone with the corresponding address value of the duplicated medium.

Therefore, when reproducing the duplicated medium, it is impossible to extract one of the pieces of the information from the zone B to the overlapping zone of the original medium from the duplicated medium. Accordingly, some pieces of the information on the original medium remain without being copied to the duplicated medium. Referring to FIG. 6c, FIG. 6c shows the information on the duplicated medium, when the information is copied from the auxiliary content session 102 of the copy-protected optical recording medium according to the present invention in the sequence shown in FIG. 6a. In FIG. 6c, only the information on the zone B is copied.

Moreover, if the driving information is properly copied onto the duplicated medium, when the duplicated medium is reproduced, the reverse progress instruction is given before or after the area of the duplicated medium corresponding to the overlapping zone so that the information on the area is extracted repeatedly. In the example shown in FIG. 6c, the information on the zone B of the original medium will be extracted repeatedly.

Therefore, in the duplicated medium, a pieces of data extracted on the position to which the specific address is allocated are the same each other in disregard of the reproducing progress direction. That is different from the case a pieces of data on the position to the same address is allocated can be different from each other according to the progress direction so that it is possible to discriminate the duplicated medium from the original medium.

Furthermore, according to another exemplary embodiment, when the information on the auxiliary content session 102 of the original recording medium is read, original medium discriminating information for discriminating whether or not certain medium is the original may be recorded on the zone B and the overlapping zone. That is, because the original medium discriminating information on the overlapping zone is not copied onto the duplicated medium, the original medium discriminating information is not read during the reproduction so that it is possible to discriminate the duplicated medium from the original medium.

Because of discriminating the duplicated medium from the original medium in the previous way, duplicate reproduction inhibiting instruction may be included in the driving information in order not to reproduce the medium considered as the duplicate.

Furthermore, by recording, for example, second reverse progress instruction onto the overlapping zone, when the reproducing apparatus no reproduces the duplicated medium without the second reverse progress instruction, it reads the information on the overlapping zone, and returns to the first position of the duplicated medium, so after all it operates improperly.

According to further another exemplary embodiment, by recording all or a part of the application programs required for reproducing the information on the recording medium onto the overlapping zone, it may be impossible to reproduce the duplicated medium.

As described above, any part of the optical recording medium according to the present invention cannot be copied successfully.

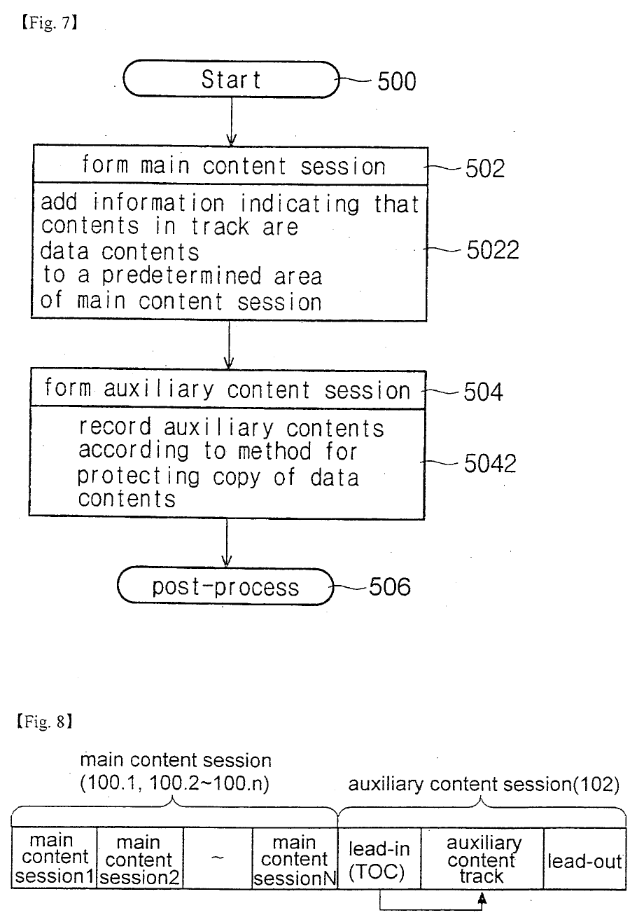

Next, an exemplary embodiment of the method for manufacturing the optical recording medium according to the present invention will now be described in detail with FIG. 7. FIG. 7 is a schematic flow chart showing the exemplary embodiment of the method for manufacturing the copy-protected optical recording medium according to the present invention. As shown in FIG. 7, the manufacturing process of the copy-protected optical recording medium first starts (step 500), a pre-process is completed by the known method, and the main content session 100 on which the contents such as the audio contents are recorded is formed (step 502).

Particularly, in this step 502, it is included that the information indicating that the contents of the tracks(track 1 to track N) on the main content session 100 are the data contents is included in a predetermined area of the main content session 100(step 5022). According to this embodiment, the information indicating that the information on the main content session 100 is the data contents is included in the TOC of the main content session 100 in the step 5022.

The auxiliary content session 102 then is formed (step 504). Particularly, in this step 504, it is included that the auxiliary contents are recorded according to the method for protecting the copying the data contents(step 5042). According to this embodiment, the auxiliary contents are recorded in the auxiliary content session 102 in the step 5042.

Following the step 504, the post-process, which is known, is performed in respect of the method for manufacturing the copy-protected optical recording medium according to the present invention.

Meanwhile, due to the recent commercialization of the computer recordable optical recording medium, it is surely possible to prevent the illegal copying of the recorded information by performing the method including the step 502 to 504 above.

Next, according to another embodiment of the present invention, the present invention is also applied to the optical recording medium including a number of the main content sessions. Referring to FIG. 8, FIG. 8 shows the information, which is imaginarily placed in a row, recorded on the copy-protected optical recording medium according to another exemplary embodiment of the present invention. In FIG. 8, the audio CD to which this invention is applied is taken as an example.

As shown in FIG. 8, the copy-protected audio CD according to the present invention includes a plurality of main content sessions 100.1, 100.2 . . . 100.n in which the audio contents are recorded, and further includes an auxiliary content session 102 for preventing the copying. The main content sessions 100.1, 100.2 . . . 100.n include lead-in areas with TOCs not shown, a plurality of tracks in which the audio content information is recorded and lead-out areas. Moreover, an auxiliary session 102 includes a lead-in area with a TOC, a first auxiliary track, a second auxiliary track and a lead-out area.

On each of the lead-in areas of the main content sessions 100.1, 100.2 . . . 100.n with the TOCs having the general structure, the control information for reproducing each of tracks (not shown in drawing) included in the main content sessions 100.1, 100.2 . . . 100.n is recorded, which includes the information indicating that all the information on each of the tracks on the main content sessions 100.1, 100.2 . . . 100.n is the data contents.

Moreover, all the description about the auxiliary content session according to the embodiment in regard to FIG. 4 is equally applied to the audio CD according to this embodiment.

Therefore, when the audio CD according to the present invention is inserted into the reproducing apparatus, the reproducing apparatus reproduces the audio contents on the main content session 100.1, 100.2 . . . 100.n according to the kind of the reproducing apparatus or by extracting the data contents on the auxiliary content session 102 and with the support of the corresponding applications.

If copying the audio CD according to the present invention, however, a recording apparatus(e.g., a CD-ROM driver; not shown in drawing) misreads that the information on the main content session is not the audio contents but the data contents by the control field of the TOC in the main content session 100, and thus can not copy the contents properly. Moreover, the information on the auxiliary session 102 cannot also be copied, so any part of the optical recording medium according to the present invention is not copied successfully after all.

Except that this embodiment of the method for manufacturing the optical recording medium according to the present invention requires the step of forming the main content session 100.1, 100.2 . . . 100.n in regard to the FIG. 5, it is the same as the previous embodiment, so the description in detail of it will be omitted.

Although the present invention has been described by way of exemplary embodiments, it should be understood that those skilled in the art might make many changes and substitutions without departing from the spirit and the scope of the present invention which is defined only by the appended claims.

Furthermore, this invention is not applied only to the audio CD but also to the entire optical recording medium using the same or similar method to this invention in order to control the reproduction and the recording.

### Industrial Applicability

According to the present invention, it is possible to provide a copy-protected optical medium capable of being reproduced without an additional reproducing apparatus and a method for manufacturing thereof.

1. An optical recording medium protected from being copied by a general reproducing apparatus, comprising:
a main content session on which content information to be reproduced by said reproducing apparatus is recorded, said main content session comprising information indicating that said content information is a data content capable of being reproduced in support of a predetermined application program; and
an auxiliary content session on which auxiliary content information is recorded according to a method for protecting said data content from being copied, said auxiliary content information is formed by converting said content information.

2. An optical recording medium as claimed in claim 1, wherein said main content session further comprises:
a lead-in area with a TOC;
at least one track on which said content information is recorded; and
a lead-out area.

3. An optical recording medium as claimed in claim 2, wherein said information indicating that said content information is a data content capable of being reproduced in support of a predetermined application program, is recorded on said TOC.

4. An optical recording medium as claimed in claim 1, wherein said content information is audio information.

5. An optical recording medium as claimed in claim 1, wherein said application program is provided by a computer system in which said reproducing apparatus is installed.

6. An optical recording medium as claimed in claim 1, wherein said application program is recorded on a predetermined area of said optical recording medium.

7. An optical recording medium as claimed in claim 1, wherein said auxiliary content session further comprises at least one OHD area provided in areas of said auxiliary contents.

8. An optical recording medium as claimed in claim 1, wherein said auxiliary content session further comprises:
at least one overlapping zone whose address values allocated to said zone overlap with address values of another area in said optical recording medium; and
driving information for controlling said reproducing apparatus to read information on said overlapping zone.

9. An optical recording medium as claimed in one of claim 1 to claim 8, further comprising at least two or more of said main content session.

10. A method for manufacturing an optical recording medium protected from being copied by a general reproducing apparatus, comprising the steps of:
(a) forming a main content session on which content information to be reproduced by said reproducing apparatus is recorded; and
(b) forming an auxiliary content session on which auxiliary content information is recorded, said auxiliary content information is formed by converting said content information,
wherein information, which indicates that said content information is a data content capable of being reproduced in support of a predetermined application program, is recorded on a predetermined area of said main content session in said step (a), and
said auxiliary content information is recorded according to a method for protecting said data content from being copied in said step (b).

11. A method for manufacturing an optical recording medium as claimed in claim 10, wherein said main content session further comprises:
a lead-in area with a TOC;
at least one track on which said content information is recorded; and
a lead-out area.

12. A method for manufacturing an optical recording medium as claimed in claim 11, wherein said information indicating that said content information is a data content capable of being reproduced in support of a predetermined application program is recorded on said TOC.

13. A method for manufacturing an optical recording medium as claimed in claim 10, wherein said content information is audio information.

14. A method for manufacturing an optical recording medium as claimed in claim 10, further comprising the step of recording said application program onto a predetermined area of said optical recording medium.

15. A method for manufacturing an optical recording medium as claimed in claim 10, wherein said auxiliary content session further comprises at least one OHD area provided in areas of said auxiliary contents.

16. A method for manufacturing an optical recording medium as claimed in claim 10, wherein said auxiliary content session further comprises at least one overlapping zone whose address values allocated to said auxiliary content overlap with address values of another area in said optical recording medium; and
driving information for controlling said reproducing apparatus to read information in said overlapping zone.

17. A method for manufacturing an optical recording medium as claimed in one of claim 10 to claim 16, further comprising the step of forming at least two or more of said main content session.
